(19) United States
(12) Patent Application Publication
(10) Pub. No.: US 2016/0001235 A1
(43) Pub. Date: Jan. 7, 2016

(54) Filtration membranes

(71) Applicant: SIMON FRISK, Newark, DE (US)

(72) Inventor: SIMON FRISK, Newark, DE (US)

(73) Assignee: E I DU PONT DE NEMOURS AND COMPANY, Wilmington, DE (US)

(21) Appl. No.: 14/788,956

(22) Filed: Jul. 1, 2015

Related U.S. Application Data
(60) Provisional application No. 62/021,264, filed on Jul. 7, 2014.

(51) Int. Cl. B01D 71/68; B01D 67/00; B01D 69/02; C08J 9/12; B01D 69/12

(52) U.S. Cl. CPC B01D 71/68; C08J 9/12; B01D 69/12; B01D 69/02; B01D 69/122; B01D 67/0011; B01D 67/0013; C08J 2381/06; B01D 2325/02; B01D 2325/04; B01D 2325/40

(57) ABSTRACT

A porous membrane constructed of a cast polymeric film with a face located adjacent to at least a portion of the surface of a nanofiber substrate fabric. The membrane is not formed by lamination of two independent layers one layer being the film and the other being the substrate fabric.

### FIELD OF THE INVENTION

This invention relates to membranes for use in liquid filtration applications.

### BACKGROUND OF THE INVENTION

Filtration membranes are highly efficient media for sub-micron separation tasks. Due to their fragile nature, they often need a physical substrate for better handling or to withstand the operating conditions of the end use application, in particular when used in cross-flow systems. Nonwovens are used as casting substrates for microfiltration, ultrafiltration, nanofiltration, and reverse osmosis membranes. They are typically made from staple fibers by drylaid or wetlaid technology. A controlled thermal bonding and calendering processes is used to impart a high degree of uniformity and fiber bonding (mechanical integrity). These nonwovens can have different weights, permeabilities, and fiber polymers types (e.g. polyester or polypropylene/polyethylene). The choice of the nonowoven substrate is made in order to be suitable for the individual manufacturing and operating conditions in the casting process.

Membrane substrates (or support fabrics) require a high degree of consistency, uniformity and an imperfection-free surface for coating. The surface must be exceptionally flat and very smooth without loose or standing fibers. Standing fibers may be the single biggest ongoing headache for membrane manufacturers.

When individual or groups of fibers are loose or stand up above the plane of the substrate, it is impossible for the polymer to form an uninterrupted imperfection-free surface during the casting process. These surface imperfections typically cause defects in the membrane, such as pinholes or larger voids.

When fibers protrude vertically or randomly upward from the horizontal fabric coating surface plane, problems arise. Unless these fibers are flattened onto the web by an additional process, they cause the liquid polymer to flow around or migrate away from the fiber. Pinholes and defects form as the polymer begins to solidify during the casting process.

Inherent characteristics of the current substrates therefore impart limitations to the membrane formation process and thus ultimately limiting the performance. A new type of substrate is needed to enable improvements in both the membrane manufacturing process and, more importantly the performance (e.g. higher flux). In addition, thinner membranes will result in additional active area in a given device geometry (i.e. volume), thus reducing the size and footprint of systems in the field for an equivalent performance.

### SUMMARY

In one embodiment, the present invention is directed to a porous membrane comprising a cast polymeric porous film with a face located adjacent to and in contact with at least a portion of the surface of a nanofiber substrate fabric. The substrate has a thickness and the membrane is prepared by a process comprising the step of casting the film directly onto the substrate fabric.

The porous film may further inter-penetrate the substrate fabric at least partially into the thickness of the substrate layer. By “inter-penetrate” is meant that the thickness of the material of which the porous film is made extends into the pore structure of the substrate fabric over at least a region of the surface of the substrate fabric. The porous film may further inter-penetrate the substrate fabric to a depth of at least 1 micron, to a depth of at least 10% of the thickness of the substrate layer, or to at least at one point to a depth of at least 2 layers of nanofibers of the substrate layer, or through the entire substrate thickness.

The polymeric porous film may have a total thickness of 200 micron or less, wherein the total thickness does not include any portion of the porous film that inter penetrates the substrate layer.

The pore size of the porous film may be smaller than the pore size of the nanofiber substrate.

The nanofiber substrate fabric may comprise fibers that are manufactured by a process selected from the group consisting of electrospinning, electroblowing, melt spinning, and melt fibrillation.

The nanofiber substrate fabric may be a nonwoven.

The membrane structure may have an average thickness of from about 25 μm to about 500 μm, from about 100 μm to about 300 μm, or from about 25 μm to about 100 μm.

The membrane may have a mean pore size in the range of 5 nm to 10 μm, or from 5 nm to 100 nm, or from 0.1 μm to 1 μm, or from 1 μm to 10 μm.

The membrane may further comprise an interfacially-polymerized thin film layer with a face located adjacent to the cast polymeric porous film.

The invention is further directed to a method for separation, the method comprising the step of creating a flux of liquid across a porous membrane comprising a polymeric film of any of the embodiments above, located adjacent to at least a portion of the surface of a nanofiber substrate fabric.

In a further embodiment, the membrane is prepared by a process comprising the step of interfacially polymerizing a film directly onto the nanofiber substrate fabric.

The method may also include the step of creating a fluid flux across the membrane by creating a fluid pressure differential across the membrane mechanically or hydraullically, for example using a pump or a hydraulic device.

The method may also include the step of creating a fluid flux across the membrane by creating a fluid pressure differential across the membrane by an osmotic effect wherein the fluid pressure differential is caused by the difference in chemical potential between a solute in two solutions on opposite sides of the membrane.

The invention is further directed to a method of making the membrane in any embodiment described above, where the nanofiber substrate may be polyethersulfone and the porous film is cast from a casting solution comprising an amide solvent

The amide solvent may be dimethyl acetamide or dimethyl formamide.

### BRIEF DESCRIPTION OF THE FIGURES

FIG. 1 shows scanning electron micrographs of a membrane of the invention in cross section.

FIG. 2 shows further scanning electron micrographs of a membrane of the invention in cross section.

FIG. 3 shows still further scanning electron micrographs of a membrane of the invention in cross section.

FIG. 4 shows SEM images of the membrane surface (top), the substrate bottom surface (bottom) and the cross-section of examples of the invention.

### DESCRIPTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used in the specification and the appended claims, the singular forms “a,” “an” and “the” include plural referents unless the context clearly dictates otherwise. Thus, for example, reference to “a composition,” “a fiber,” or “a step” includes mixtures of two or more such functional compositions, fibers, steps, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

A residue of a chemical species, as used in the specification and concluding claims, refers to the moiety that is the resulting product of the chemical species in a particular reaction scheme or subsequent formulation or chemical product, regardless of whether the moiety is actually obtained from the chemical species. Thus, an ethylene glycol residue in a polyester refers to one or more —OCH₂CH₂O— units in the polyester, regardless of whether ethylene glycol was used to prepare the polyester. Similarly, a sebacic acid residue in a polyester refers to one or more —CO(CH₂)₈CO— moieties in the polyester, regardless of whether the residue is obtained by reacting sebacic acid or an ester thereof to obtain the polyester.

### DEFINITIONS

As used herein, the terms “optional” or “optionally” means that the subsequently described event or circumstance can or cannot occur, and that the description includes instances where said event or circumstance occurs and instances where it does not.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers. Homopolymers (i.e., a single repeating unit) and copolymers (i.e., more than one repeating unit) are two categories of polymers.

As used herein, the term “homopolymer” refers to a polymer formed from a single type of repeating unit (monomer residue).

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “segmented polymer” refers to a polymer having two or more chemically different sections of a polymer backbone that provide separate and distinct properties. These two sections may or may not phase separate. A “crystalline” material is one that has ordered domains (i.e., aligned molecules in a closely packed matrix), as evidenced by Differential Scanning calorimetry, without a mechanical force being applied. A “noncrystalline” material is one that is amorphous at ambient temperature. A “crystallizing” material is one that forms ordered domains without a mechanical force being applied. A “noncrystallizing” material is one that forms amorphous domains and/or glassy domains in the polymer at ambient temperature.

Polymers that are suitable for use in the nanofiber substrate layer of the invention include polyethersulfones, polysulfones, polyimides, polyvinylidene fluorides, polytethylene terephthalates, polybutylene terephthalates, polypropylene terephthalates, polypropylenes, polyethylenes, polyacrylonitriles, polyamides, and polyaramids.

Polymers that are suitable for use in the cast film of the invention include polyamides, polyethers, polyether-ureas, polyesters, polyimides, polysulfones, polyethersulfones, polyvinylidene fluoride, polyacrylonitrile or a copolymer or a mixture of any of the preceding.

The term “nanofiber” as used herein refers to fibers having a number average diameter or cross-section less than about 1000 nm, even less than about 800 nm, even between about 50 nm and 500 nm, and even between about 100 and 400 nm. The term diameter as used herein includes the greatest cross-section of non-round shapes.

The term “nanofiber substrate layer” as applied herein refers to a nonwoven or ordered (for example woven) web constructed of a large fraction of nanofibers. Large fraction means that greater than 25%, even greater than 50% of the fibers in the web are nanofibers, where the term “nanofibers” as used herein refers to fibers 15 having a number average diameter less than 1000 nm, even less than 800 nm, even between about 50 nm and 500 nm, and even between about 100 and 400 nm. In the case of non-round cross-sectional nanofibers, the term “diameter” as used herein refers to the greatest cross-sectional dimension. The nanoweb of the invention can also have greater than 20, 70%, or 90% or it can even contain 100% of nanofibers.

By “layers of nanofibers” is meant separately laid down fibers forming layers in which the fibers of different layers are not highly and uniformly entangled as they would be if they were woven together. Each layer can be approximated as being the thickness of a single fiber diameter.

The porosity of the nonwoven web material is equivalent to 100× (1.0—solidity) and is expressed as a percentage of free volume in the nonwoven web material structure wherein solidity is expressed as a fraction of solid material in the nonwoven web material structure.

“Mean pore size” is measured according to ASTM Designation E 1294-89, “Standard Test Method for Pore Size Characteristics of Membrane Filters Using Automated Liquid Porosimeter.” Individual samples of different size (8, 20 or 30 mm diameter) are wetted with a low surface tension fluid (1,1,2,3,3,3-hexafluoropropene, or “Galwick,” having a surface tension of 16 dyne/cm) and placed in a holder, and a differential pressure of air is applied and the fluid removed from the sample. The differential pressure at which wet flow is equal to one-half the dry flow (flow without wetting solvent) is used to calculate the mean pore size using supplied software.

The term “nonwoven” means a web including a multitude of randomly distributed fibers. The fibers generally can be bonded to each other or can be unbonded. The fibers can be staple fibers or continuous fibers. The fibers can comprise a single material or a multitude of materials, either as a combination of different fibers or as a combination of similar fibers each comprised of different materials. A “nanoweb” is a nonwoven web that comprises nanofibers.

“Calendering” is the process of passing a web through a nip between two rolls. The rolls may be in contact with each other, or there may be a fixed or variable gap between the roll surfaces. An “unpatterned” roll is one which has a smooth surface within the capability of the process used to manufacture them. There are no points or patterns to deliberately produce a pattern on the web as it passed through the nip, unlike a point bonding roll.

Classical electrospinning is a technique illustrated in U.S. Pat. No. 4,127,706, incorporated herein in its entirety, wherein a high voltage is applied to a polymer in solution to create plexifilamentarys and nonwoven mats. However, total throughput in electrospinning processes is too low to be commercially viable in forming heavier basis weight webs.

The “electroblowing” process is disclosed in World Patent Publication No. WO 03/080905, incorporated herein by reference in its entirety. A stream of polymeric solution comprising a polymer and a solvent is fed from a storage tank to a series of spinning nozzles within a spinneret, to which a high voltage is applied and through which the polymeric solution is discharged. Meanwhile, compressed air that is optionally heated is issued from air nozzles disposed in the sides of, or at the periphery of the spinning nozzle. The air is directed generally downward as a blowing gas stream which envelopes and forwards the newly issued polymeric solution and aids in the formation of the fibrous web, which is collected on a grounded porous collection belt above a vacuum chamber.

As used herein the term “meltblown fibers” means fibers formed by extruding a molten thermoplastic material through a plurality of fine, usually circular, die capillaries as molten threads or filaments into a high velocity gas (e.g. air) stream which attenuates the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin. Meltblown fibers are microfibers which are generally smaller than 10 microns in diameter. The term meltblowing used herein is meant to encompass the meltspray process.

By melt fibrillation is meant the process of producing submicron fibers by longitudinally splitting fibers or sheets that may be in the solid or melt form. A melt film tube is produced from the melt and then a fluid is used to form nanofibers from the film tube. Two examples of this method include Torobin's U.S. Pat. Nos. 6,315,806; 5,183,670; and 4,536,361; and Reneker's U.S. Pat. Nos. 6,382,526 and 6,520,425, assigned to the University of Akron. Although these methods are similar by first forming a melt film tube before the nanofibers result, the processes use different temperatures, flow rates, pressures, and equipment.

Film fibrillation is another method of producing nanofibers although not designed for the production of polymeric nanofibers to be used in nonwoven webs. U.S. Pat. No. 6,110,588 by Perez et al., assigned to 3M, describes of method of imparting fluid energy to a surface of a highly oriented, highly crystalline, melt-processed polymer film to form nanofibers. The films and fibers are useful for high strength applications such as reinforcement fibers for polymers or cast building materials such as concrete.

Two-step methods of producing nanofibers are also known. A two-step method is defined as a method of forming fibers in which a second step occurs after the average temperature across the fiber is at a temperature significantly below the melting point temperature of the polymer contained in the fiber. Typically, the fibers will be solidified or mostly solidified. The first step is to spin a larger diameter multicomponent fiber in an islands-in-the-sea, segmented pie, or other configuration. The larger diameter multicomponent fiber is then split or the sea is dissolved so that nanofibers result in the second step. For example, U.S. Pat. No. 5,290,626 by Nishio et al., assigned to Chisso, and U.S. Pat. No. 5,935,883, by Pike et al., assigned to Kimberly-Clark, describe the islands-in-the-sea and segmented pie methods respectively. These processes involve two sequential steps, making the fibers and dividing the fibers.

By “casting” is meant the process of producing a porous or microporous film by laying down a polymer solution and subsequently subjecting it to a process that induces porosity in the film. Solvent is removed in the process of producing the film.

Microporous film manufacturing techniques include, but are not limited to, phase inversion, membrane stretching, and irradiation. Of these, phase inversion is the most common. In this process the membrane is formed when two phases are formed. One phase has a high concentration of the chosen polymer and a low concentration of solvents and forms a solid. The other phase stays a liquid and has a lower concentration of polymer and a higher concentration of solvents and forms the pores of the membrane. The polymer-rich phase can be precipitated using solvent evaporation, polymer cooling, and absorption of a non-solvent (e.g. water) from the vapor phase, and by precipitation in a non-solvent in the liquid phase.

Almost all, ultrafiltration, microfiltration, and many gas separation membranes and the support layers in reverse osmosis and nanofiltration membranes, are formed by phase inversion.

Solvent evaporation is an alternative method of membrane formation. A polymer is dissolved in a mixture consisting of a volatile solvent (i.e. acetone, hexane) and a non-solvent (i.e. water or an alcohol). The membrane is spread out on a solid surface such as glass. As the volatile solvent evaporates, the polymer precipitates as it reaches is solubility limit with the non-solvent. The non-solvent, which is not as volatile, remains in the polymer and forms pores. The pore structure and size can be controlled by the rate of evaporation and the endpoint of the evaporation—the formation of pores can be stopped by immersing the membrane in water or some other non-solvent.

In vapor-phase precipitation, a polymer mixture consisting of the polymer, a volatile solvent and sometimes a non-volatile solvent is spread thinly or cast on a surface. The membrane is placed in an atmosphere saturated with the volatile solvent and containing a non-solvent (e.g. water vapor). The non-solvent penetrates the polymer mixture and causes the polymer to precipitate. The solvent is not able to evaporate into the solvent saturated atmosphere.

In the polymer cooling method, a hot polymer solution is cast without a non-solvent. As the polymer cools, it phase-separates into a porous membrane with the pores formed by dispersed cells of the solvent. The rate of cooling determines the size of the pores with rapid cooling producing small pores. The total pore volume is determined by the amount of solvent in the polymer mixture. Polymer cooling can be used to make both flat sheet and hollow-fibers.

Precipitation in a Non-Solvent is a phase inversion process that involves the precipitation of the polymer mixture directly into a non-solvent—usually water. The polymer mixture, which may contain a non-solvent to enhance pore formation, is immediately precipitated upon contact with a bulk non-solvent phase containing one or more non-solvents. The membrane solution is cast onto a moving drum often along with a substrate layer. The membrane thickness is defined and controlled by a casting blade. The surface of the membrane precipitates forms a relatively dense surface. The interior of the membrane precipitates more slowly allowing larger pores to form. The precipitated membrane is passed into a second tank where the remaining solvent is rinsed to stop the pore formation process.

By “interfacial polymerization” is meant a layer that is obtained by a polycondensation reaction in situ, here on the surface of the substrate or support layer. For example, for reverse osmosis membranes such a layer often obtained by an interfacial polycondensation reaction between a polyfunctional amine monomer and a polyfunctional acyl halide monomer (also referred to as a polyfunctional acid halide) as described in, for example, U.S. Pat. No. 4,277,344. The polyamide discriminating layer for nanofiltration membranes is typically obtained via an interfacial polymerization between a piperazine or an amine substituted piperidine or cyclohexane and a polyfunctional acyl halide as described in U.S. Pat. Nos. 4,769,148 and 4,859,384. Another way of obtaining polyamide discriminating layers suitable for nanofiltration is via the methods described in, for example, U.S. Pat. Nos. 4,765,897; 4,812,270; and 4,824,574. These patents describe changing a reverse osmosis membrane, such as those of U.S. Pat. No. 4,277,344, into a nanofiltration membrane.

Thin film composite polyamide membranes are typically prepared by coating a porous support with a thin film comprising a polyfunctional amine monomer, most commonly coated from an aqueous solution. Although water is a preferred solvent, non-aqueous solvents may be utilized, such as acetyl nitrile and dimethylformamide (DMF). A polyfunctional acyl halide monomer (also referred to as acid halide) is subsequently coated on the support, typically from an organic solution. Although no specific order of addition is necessarily required, the amine solution is typically coated first on the porous support followed by the acyl halide solution. Although one or both of the polyfunctional amine and acyl halide may be applied to the porous support from a solution, they may alternatively be applied by other means such as by vapor deposition, or neat. The porous support is typically formed of a coarse nonwoven substrate on which was cast a microporous film.

### EMBODIMENTS OF THE INVENTION

In one embodiment, the present invention is directed to a porous membrane comprising a cast polymeric porous film with a face located adjacent to and in contact with at least a portion of the surface of a nanofiber substrate fabric. The substrate has a thickness and the membrane is prepared by a process comprising the step of casting the film directly onto the substrate fabric.

The porous film may further inter-penetrate the substrate fabric at least partially into the thickness of the substrate layer. By “inter-penetrate” is meant that the thickness of the material of which the porous film is made extends into the pore structure of the substrate fabric over at least a region of the surface of the substrate fabric. The porous film may further inter-penetrate the substrate fabric to a depth of at least 1 micron, to a depth of at least 10% of the thickness of the substrate layer, or to at least at one point to a depth of at least 2 layers of nanofibers of the substrate layer, or through the entire substrate thickness.

The polymeric porous film may have a total thickness of 200 micron or less, wherein the total thickness does not include any portion of the porous film that inter penetrates the substrate layer.

The pore size of the porous film may be smaller than the pore size of the nanofiber substrate.

The nanofiber substrate fabric may comprise fibers that are manufactured by a process selected from the group consisting of electrospinning, electroblowing, melt spinning, and melt fibrillation.

The nanofiber substrate fabric may be a nonwoven.

The membrane structure may have an average thickness of from about 25 μm to about 500 μm, from about 100 μm to about 300 μm, or from about 25 μm to about 100 μm.

The membrane may have a mean pore size in the range of 5 nm to 10 μm, or from 5 nm to 100 nm, or from 0.1 μm to 1 μm, or from 1 μm to 10 μm.

The membrane may further comprise an interfacially-polymerized thin film layer with a face located adjacent to the cast polymeric porous film.

The invention is further directed to a method for separation, the method comprising the step of creating a flux of liquid across a porous membrane comprising a polymeric film of any of the embodiments above, located adjacent to at least a portion of the surface of a nanofiber substrate fabric.

In a further embodiment, the membrane is prepared by a process comprising the step of interfacially polymerizing a film directly onto the nanofiber substrate fabric.

The method may also include the step of creating a fluid flux across the membrane by creating a fluid pressure differential across the membrane mechanically or hydraullically, for example using a pump or a hydraulic device.

The method may also include the step of creating a fluid flux across the membrane by creating a fluid pressure differential across the membrane by an osmotic effect wherein the fluid pressure differential is caused by the difference in chemical potential between a solute in two solutions on opposite sides of the membrane.

The invention is further directed to a method of making the membrane in any embodiment described above, where the nanofiber substrate may be polyethersulfone and the porous film is cast from a casting solution comprising an amide solvent

The amide solvent may be dimethyl acetamide or dimethyl formamide.

### EXAMPLES

### Test Methods

“Mean flow pore size” is measured according to ASTM Designation E 1294-89, “Standard Test Method for Pore Size Characteristics of Membrane Filters Using Automated Liquid Porosimeter.” Individual samples of different size (8, 20 or 30 mm diameter) are wetted with a low surface tension fluid (1,1,2,3,3,3-hexafluoropropene, or “Galwick,” having a surface tension of 16 dyne/cm) and placed in a holder, and a differential pressure of air is applied and the fluid removed from the sample. The differential pressure at which wet flow is equal to one-half the dry flow (flow without wetting solvent) is used to calculate the mean flow pore size using supplied software.

Mean flow pore size of the claimed membrane structure involves the measurement above performed with the film plus substrate composite structure.

Basis weight (BW) was determined by ASTM D-3776, which is hereby incorporated by reference and reported in g/m² (gsm).

The thicknesses reported of the total membrane (film+substrate) in table 2 were measured in mil (thousands of an inch) and were determined using a handheld dial thickness gauge with a 0.0010 inch resolution. The value in mil was converted to microns for reporting here, by multiplying by 25.4.

The thicknesses of the other films and membranes reported in microns were determined using an automated precision thickness gauge (Hanatek FT3-V) following ASTM D-645 (or ISO 534), which is hereby incorporated by reference, under an applied load of 10 kPa.

The water permeability of the samples was determined by two ways. In the first setup, 1.5″ by 3.5″ samples (already wet) were placed in a custom made flat sheet tester. The membrane surface is subjected to a pressurized flow of deionized water at 25° C. After an initial intentional pressure spike at 160 psi, the pressure was set at 40 psi. After 1 minute, the water flowing through the membrane was collected for 15 seconds. The water flux is calculated by dividing the amount of water collected by the collection time (e.g. grams per second). The water flux permeability constant (A-value) was then calculated by normalizing the flux to the surface area of the sample and the applied water pressure, and reported in grams per centimeter square per second per atmosphere of water pressure. The second setup consisted of a lab scale flat sheet crossflow filtration unit (Sterlitech CF042, Sterlitech Corporation, Kent, Wash.). With this unit, deionized water was recirculated across the surface of the membranes at a given flow rate (2 liters per minute) and pressure (45 psi) for a certain time. At a chosen moment (90 minutes after the start of the experiment), the volume of water flowing through the membrane over a given time is determined (e.g. in grams per min), which is defined as the clean water flux (CWF). The CWF can then be normalized by the surface area of the membrane (42 cm2), applied water pressure across the membrane (45 psi) and reported in liters per square meters per hour per bar (LMH/bar).

The separation performance of the membranes was determined by filtering an aqueous solution of starch molecules of a broad molecular weight distribution. The starch solution was obtained from the fermentation of corn followed by a microfiltration step (0.1 μm membrane) to remove the solids. The starch concentration in the feed is expected to be between 100 and 200 grams per kilograms of solution. The starch solution was used as a feed in the CF042 laboratory crossflow filtration unit described above. The solution was recirculated at the same process conditions as described above. The filtrate was collected for 1 minute after 70 minutes of recirculation. The feed solution and the filtrate were analyzed by infrared spectroscopy. The difference in the intensity of the 1050 cm-1 absorption band was used to determine the overall difference in starch concentration between the feed solution and the filtrate.

Substrate Materials

Nanofiber based nonwoven products having different structural properties and polymer type were used to prepare the various examples (Table 1). All nanowebs were produced by the Electroblowing process according to the process described in patent application publication WO03/080905. All nanowebs were further consolidated by calendering according to the process described in U.S. Pat. No. 8,697,587, except for nanoweb PI-1

TABLE 1

| | | Basis | | | Mean Pore |
|---|---|---|---|---|---|
| | | Weight | Thickness | Porosity | Size |
| Substrate | Polymer | g/m2 | μm | % | μm |
| PI-1 | polyimide | 41 | 264 | 89 | 2.6 |
| PI-2 | polyimide | 40 | 75 | 62 | 1.6 |
| PI-3 | polyimide | 21 | 47 | 69 | 1.6 |
| PES-1 | polyether sulfone | 40 | 49 | 39 | 0.6 |
| PES-2 | polyether sulfone | 40 | 51 | 59 | 0.8 |
| PES-3 | polyether sulfone | 31 | 58 | 61 | 2.1 |

A commercial PET wetlaid substrate nonwoven of 82 g/m2 and 75 μm thick (Crane 414, Neenah Technical Materials, Pittsfield, Mass.) was used as a substrate for a comparative example.

### Examples 1-3

Examples 1, 2 and 3 were produced by phase inversion casting a solution of polysulfone in dimethyl acetamide (DMAc) onto a nanofiber based nonwoven substrate using the process described below.

A roll of nanofiber based nonwoven substrate roll was strung up in a typical coater. With the substrate in motion at a define speed, the polymer solution was applied to the substrate ahead of a Micrometer Adjustable Film Applicator (MTI corp., Richmond, Calif.) (i.e. knife), which dispersed and controlled the thickness of solution applied to the substrate by a preadjusted gap setting. The wet film on the substrate was then gelled and precipitated in a gelation and extraction bath containing deionized water. Finally, the completed membrane was wound up.

The characteristics of the casting solutions and the casting process parameters are summarized in Table 2. The water bath temperature was held constant at a nominal value of 21° C. Total thickness refers to the total thickness of the membrane (film plus substrate) not including the thickness of any film interpenetrating the substrate.

TABLE 2

| | | Polymer | Solvent | | |
|---|---|---|---|---|---|
| | | concen- | concen- | Total | A-value |
| | | tration | tration | Thickness | ×10⁻⁵ |
| Example | Substrate | Wt % | Wt % | (micron) | (g/cm²/s/atm) |
| 1 | PI-1 | 21 | 79 | 280 | 939 |
| 2 | PI-2 | 21 | 79 | 102 | 918 |
| 3 | PES-1 | 26 | 74 | 127 | 67 |

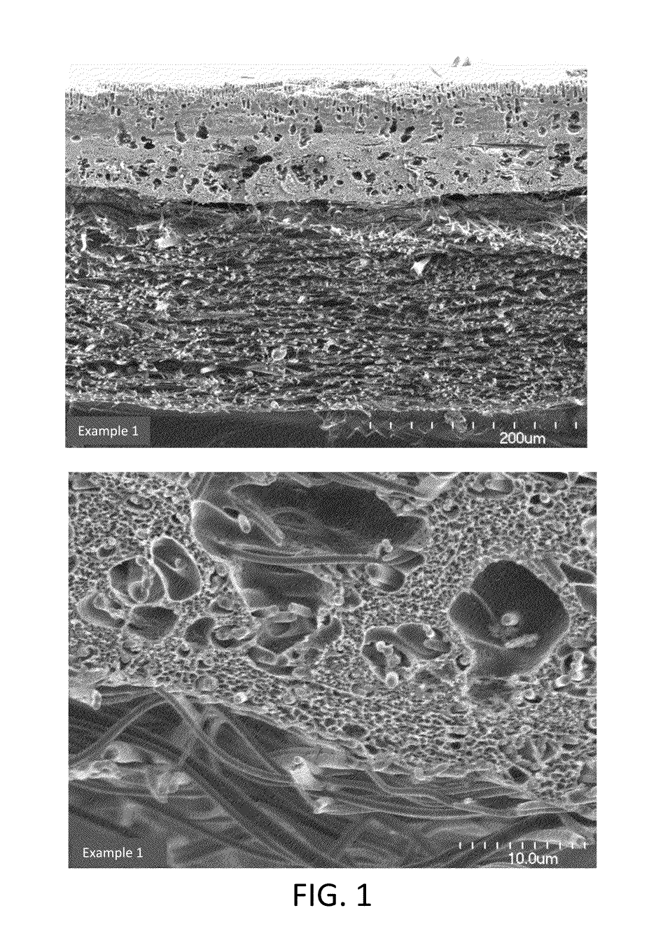

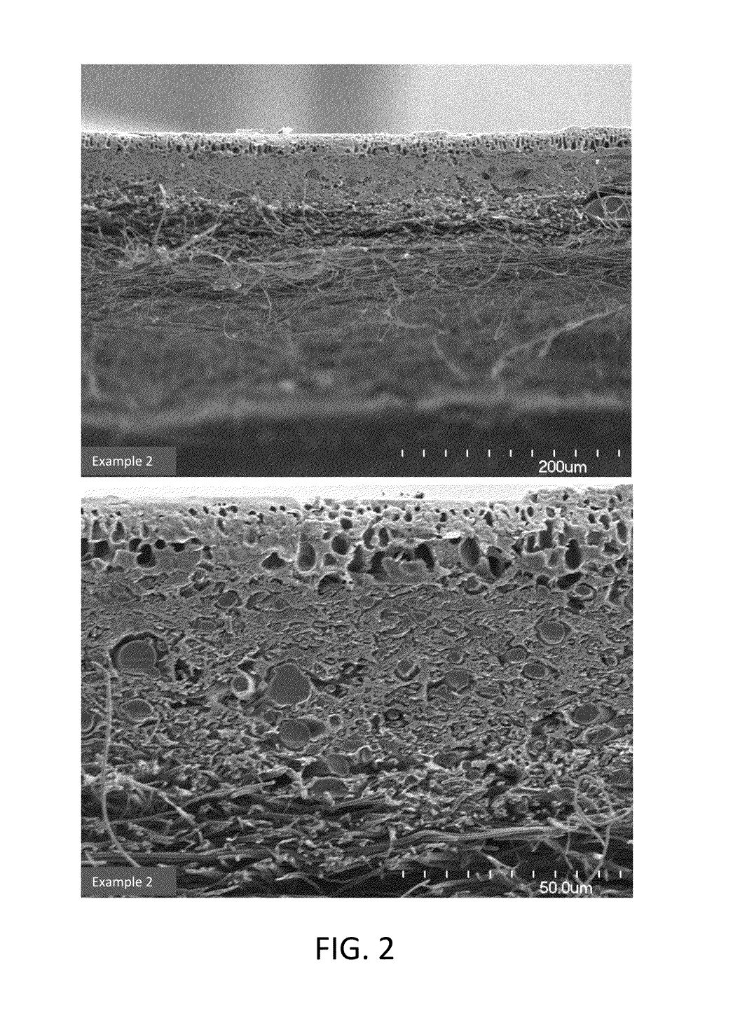

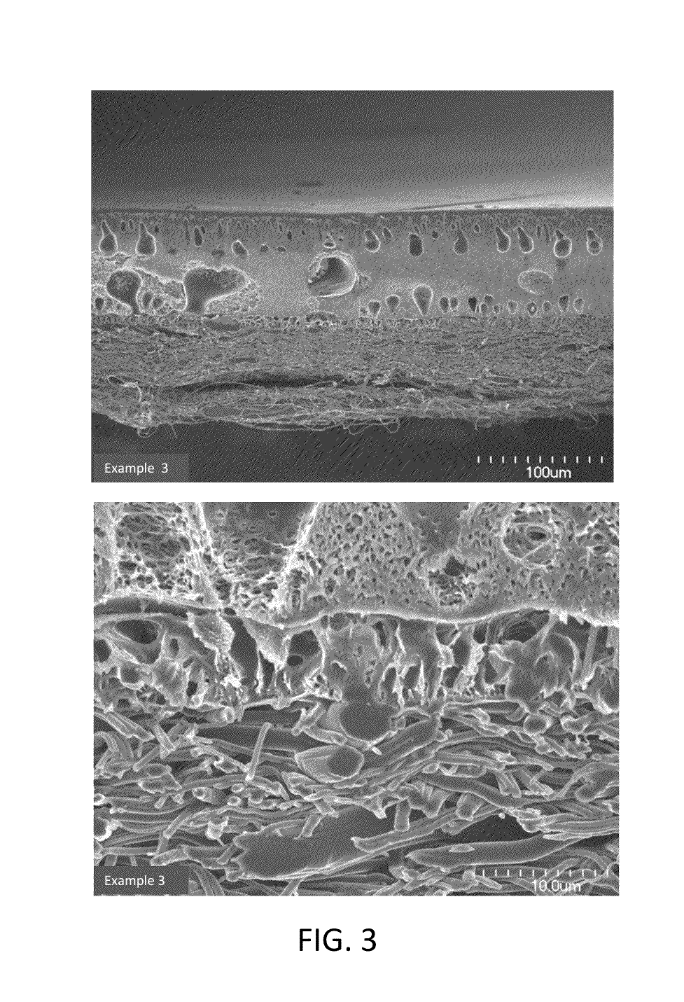

FIGS. 1-3 show SEM images of the cross-section of the three examples respectively and show membranes with different level of penetration of the porous film into the nanofiber based nonwoven substrate. Example 1 has a medium level of penetration. Example 2 has a deep level of penetration and Example 3 has a low level of penetration.

### Examples 4 and 5

Examples 4 and 5, and Comp-1 and Comp-2 were produced by casting a solution of 18.5 wt % polysulfone and 1 wt % LiBr (a pore former) in 80.5 wt % DMF solvent onto the substrates, using the process described above. The casting conditions and resulting properties are summarized in Table 3.

TABLE 3

| | | Total | A-Value |
|---|---|---|---|
| | | Thickness | ×10⁻⁵ |
| Example | Substrate | (μm) | (g/cm²/s/atm) |
| 4 | PI-3 | 70 | 3279 |
| Comp 1 | PET | 124 | 1651 |
| 5 | PI-3 | 73 | 3815 |
| Comp 2 | PET | 118 | 3262 |

The examples produced using the nanofiber substrates perform better than the corresponding comparative examples produced using the wetlaid PET substrate. They have higher water permeabilities. In addition, they have a lower thickness.

### Example 6 and 7

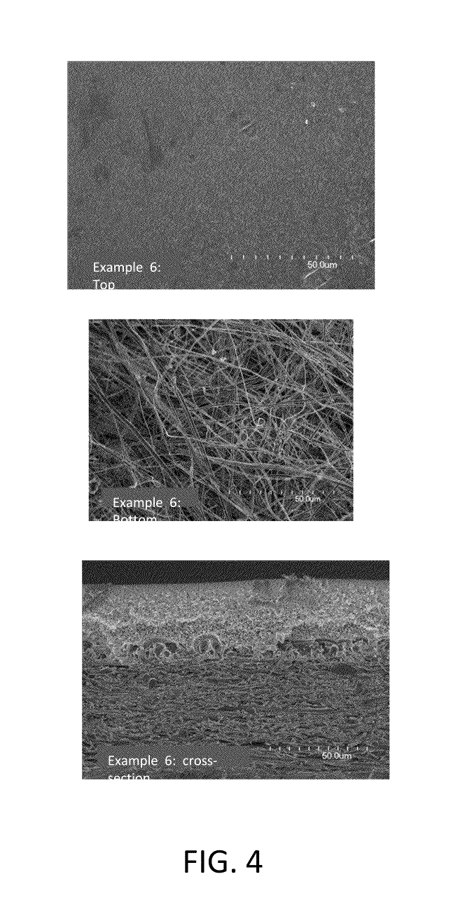

Example 6 and 7 were produced by casting two different solutions on two different polyether sulfone nanofiber substrates, using the process described above with a knife gap of about 13 μm and 20 μm, respectively, and a casting speed of 30 ft/min. Both solutions comprised a solvent that also a good solvent for the polyethersulfone used in the substrate. A solution of 16.5% by weight of total solution of polysulfone in DMF with 5% by weight of total solution of an additive (polyvinylpyrrolydone) was used to produce Example 6. DMF is a solvent for the PES polymer of the substrate. FIG. 4 shows SEM images of the membrane surface (top), the substrate bottom surface (bottom) and the cross-section showing the high quality of the membrane and the small amount of interpenetration of the porous film into the nanofiber substrate. A solution of 20% by weight of total solution polyvinylidene fluoride in N-methyl-2-pyrrolydone (NMP) was used for Example 7. NMP is also a solvent for the PES polymer. Both examples have a level of water permeability indicating that the substrate is still porous after casting (Table 4).

TABLE 4

| | | Total | A-Value |
|---|---|---|---|
| | | Thickness | ×10⁻⁵ |
| Example | Substrate | (μm) | (g/cm²/s/atm) |
| 6 | PES-2 | 106 | 263 |
| 7 | PES-3 | 120 | 879 |

### Example 8

The following example (Example 8) was produced by casting a 16.5 wt % solution of Polysulfone and 1 wt % LiBr, in 82.5 wt % dimethylformamide (DMF) using the process described above. The knife gap was 25 μm and the casting line speed was 30 ft/min. The resulting sample had a total thickness of 144 μm. The performance of Example 8 was compared to Comp-3, a commercial polysulfone ultrafiltration membrane (Nadir US100H, Microdyn-Nadir, Wiesbaden, Germany) (Table 5). The clean water flux of the Example 8 membrane is superior to that of Comp-3. The separation performance was determined by filtering a solution of starches of various molecular weights using the method described above. The intensity of the infrared absorption band at 1050 cm-1 decreased by 11% in the filtrate of Example 8 compared to the feed, indicating a certain level of separation of the starch molecules. The filtrate from the Comp-3 did not show any decrease in intensity, indicating that this membrane did not separate any of the starch molecules in the feed. Example 8 has a significantly higher water flux while still having a tighter separation characteristic than the comparative sample.

TABLE 5

| | | | Separation |
|---|---|---|---|
| | | Water flux | % IR intensity |
| Example | Substrate | (LMH/bar) | change |
| 8 | PI-2 | 155 | 11% |
| Comp-3 | — | 95 | 0% |

We claim:

1. A porous membrane comprising a cast porous polymeric film with a face located adjacent to and in contact with at least a portion of the surface of a nanofiber substrate fabric, wherein the substrate has a thickness and the membrane is prepared by a process comprising the step of casting the film directly onto the substrate fabric.

2. The membrane of claim 1 in which the film inter-penetrates the substrate fabric at least partially into the thickness of the substrate layer.

3. The membrane of claim 2 in which the film inter-penetrates the substrate fabric to a depth of at least 1 micron.

4. The membrane of claim 2 in which the film inter-penetrates the substrate fabric at least at one point to a depth of at least 10% of the thickness of the substrate layer.

5. The membrane of claim 2 in which the film inter-penetrates the substrate fabric at least one point to a depth of at least 2 layers of nanofibers of the substrate layer.

6. The membrane of claim 1 in which the polymeric porous film has a total thickness of 200 microns or less, wherein the total thickness does not include any portion of the film that inter penetrates the substrate layer.

7. The membrane of claim 1, wherein the pore size of the film is smaller than the pore size of the nanofiber substrate.

8. The membrane of claim 1, wherein the nanofiber substrate fabric comprises nanofibers that are spun from a polymer that further comprise a polyethersulfone, a polysulfone, a polymide, a polyvinylidene fluoride, a polytheylene terephthalate, a polypropylene, a polyethylene, a polyacrylonitrile, a polyamide, a polyaramid or any combination of the foregoing.

9. The membrane of claim 1, wherein the nanofiber substrate fabric comprises fibers that are manufactured by a process selected from the group consisting of electrospinning, electroblowing, melt spinning, and melt fibrillation.

10. The membrane of claim 1, wherein the nanofiber substrate fabric is a nonwoven.

11. The membrane of claim 1, wherein the film is cast from a solution that comprises at least one of a polyamide, a polyether, a polyether-urea, a polyester, a polyimide, a polysulfone, a polyether sulfone, polyvinylidene fluoride, polyacrylonitrile, or a copolymer or a mixture of any of the preceding.

12. The membrane of claim 1, having an average thickness of from 25 μm to 500 μm, from 100 μm to 300 μm, or from 25 μm to 100 μm.

13. The membrane of claim 1 where the membrane has a mean pore size in the range of 0.1 micron to 10 micron, 5 nm to 100 nm, 0.1 to 1 micron, or 1 micron to 10 microns.

14. The membrane of claim 1, where the nanofiber substrate is a polymer soluble in a set of solvents and the porous film is cast from a casting solution comprising at least one solvent from the same set.

15. The membrane of claim 14, wherein the nanofiber substrate comprises polyether sulfone and the cast film comprises polyether sulfone, polysulfone, or polyvinylidene fluoride.

16. A method of making the membrane of claim 1, where the nanofiber substrate is a polymer soluble in a set of solvents and the porous film is cast from a casting solution comprising at least one solvent from the same set.

17. The method of claim 16, where the nanofiber substrate is polyether sulfone or polyvinylidene fluoride and the porous film is cast from a casting solution comprising an amide or pyrrolidone solvent.

18. The method of claim 17 in which the amide solvent is dimethyl acetamide or dimethyl formamide, or N-methyl-2-pyrrolidone

19. The membrane of claim 1 further comprising an interfacially-polymerized film layer with a face located adjacent to the cast polymeric film

20. A method for separation, the method comprising the step of creating a flux of liquid across a porous membrane comprising a cast polymeric film located adjacent to at least a portion of the surface of a nanofiber substrate fabric, wherein the substrate has a thickness and the membrane is prepared by a process comprising the step of casting the film directly onto the substrate fabric.

21. The method of claim 20 where a fluid flux is created across the membrane by creating a fluid pressure differential across the membrane hydraulically.

22. The method of claim 20 where a fluid flux is created across the membrane by creating a fluid pressure differential across the membrane by an osmotic effect.
